(19) United States
(12) Patent Application Publication
(10) Pub. No.: US 2016/0263934 A1
(43) Pub. Date: Sep. 15, 2016

(54) Pencil Sharpener with Notification Light

(71) Applicant: Acme United Corporation, Fairfield, CT (US)

(72) Inventor: Nicholas L. Seferi, Southbury, CT (US)

(21) Appl. No.: 14/954,054

(22) Filed: Nov. 30, 2015

Related U.S. Application Data
(60) Provisional application No. 62/132,795, filed on Mar. 13, 2015.

(51) Int. Cl. B43L 23/00

(52) U.S. Cl. CPC B43L 23/008

(57) ABSTRACT

An automatic pencil sharpener includes a pencil sharpening mechanism and a sharpening switch within a central receiver configured to receive a pencil through an access opening. The pencil sharpening mechanism and sharpening switch are operatively connected to a sharpener control unit. When a pencil actuates the sharpening switch, the sharpening control unit powers the pencil sharpening mechanism and the notification light illuminates in a first color. At a subsequent event or time when the pencil is substantially fully sharpened, the notification light illuminates in a second color. The illumination is preferably produced by at least one green LED and one red LED.

### CROSS-REFERENCE TO RELATED APPLICATION

This application claims the priority of U.S. Provisional Patent Application No. 62/132,795 filed on Mar. 13, 2015, the entirety of which is incorporated by reference.

### BACKGROUND

The present disclosure relates generally to pencil sharpeners, and more particularly, to automatic pencil sharpeners that operate on electrical power.

Conventional automatic pencil sharpeners typically sharpen a pencil that is inserted and removed at the user's discretion. It is common for a user to leave the pencil in the sharpener longer than necessary. As a result, the pencil continues to sharpen and the pencil sharpener removes material beyond what is necessary, shortening the life of the pencil and putting unnecessary wear on the pencil sharpener. It would be advantageous to provide an automatic pencil sharpener that provides a notification to the user when the pencil reaches a desired sharpness.

### SUMMARY

Briefly stated, the present invention is directed to an automatic pencil sharpener having a notification light that informs a user when a pencil reaches a predetermined sharpness. The preferred pencil sharpener is a type which contains a pencil sharpener mechanism responsive to a sharpening switch accessible within a receiver of the pencil sharpener. The pencil sharpener mechanism contains a rotary blade assembly. The rotary blade assembly automatically sharpens a received pencil to a desired sharpness.

A sharpening switch is disposed within a pencil sharpening housing and is activatable by a pencil that is inserted through an access opening into the receiver. When the pencil activates the switch, the pencil sharpener mechanism starts operating and the notification light is activated. The notification light emits a dramatic illumination in a first frequency or color. Upon a subsequent operational event, the notification light is fully illuminated at a second frequency or color to indicate to the user that the pencil is completely sharpened. The illuminations can be a constant state, or flashed or pulsed in various patterns. In one embodiment, the notification light employs LEDs that illuminate in green and then illuminate in red.

In one embodiment, the pencil sharpener comprises a housing assembly having a pencil receiver extending from a first end at an exterior access opening to a second end. The access opening accommodates a pencil. A pencil sharpening mechanism is disposed in the housing assembly proximate the second end. A sharpening switch is disposed in the housing assembly and positioned to detect the presence of a pencil in the receiver. A notification light module is disposed in the housing assembly and, upon illumination, is configured to emit light visible exteriorly from the housing assembly. A control unit is operably connected to the sharpening mechanism, the sharpening switch and the notification light module, wherein when a pencil is inserted into the receiver and engages the sharpening switch, the control unit powers the pencil sharpening mechanism and causes the notification light module to illuminate.

The notification light module comprises an LED and the housing assembly has a light transmissive portion wherein light emitted from the LED is transmitted through the portion. The notification light module is preferably disposed for emitting light in the vicinity of the access opening. The pencil sharpener also comprises a switch which is activatable upon sharpening the pencil at a second position indicative of a substantially completely sharpened pencil. The notification light module comprises at least two LEDs, one LED being illuminated upon activation of the first sharpening switch and a second LED being illuminated upon activation of the second switch. The first LED emits at a first frequency which is preferably in the green range, and the second LED emits at a second frequency which is preferably in the red range. The first LED may be pulsed and the second LED may emit radiation at a steady state. The illumination from the first LED and the illumination from the second LED are generally disposed for transmission about the access opening.

The pencil sharpener may further comprise a blade guard having an upper portion, and LEDs are mounted to the circuit board disposed at an upper portion of the blade guard assembly. The blade guard assembly further includes an axial conduit which extends from the lower portion to the upper portion. A wire extends through the conduit for connecting an LED circuit board assembly to a second circuit board assembly disposed in the housing assembly.

In another embodiment, the pencil sharpener comprises a housing assembly having a receiver adjacent a first end at an exterior access opening and extending to a second end. The access opening accommodates a pencil. The housing assembly has a notification light which, upon activation, is visible exteriorly of the housing assembly. A pencil sharpener mechanism is mounted to the assembly proximate the second end. A sharpener control circuit is operatively connected to a sharpening switch and the sharpening mechanism. When a pencil is inserted in the receiver and the sharpening switch is activated, the sharpening control unit powers the pencil sharpener mechanism to sharpen a pencil and illuminates the notification light in a first color and at a subsequent time when the pencil sharpener mechanism is operating and the pencil is substantially completely sharpened, the sharpening control unit illuminates the notification light in a second color.

The notification light is preferably disposed adjacent the access opening. When the pencil is withdrawn from the receiver, the notification light ceases illumination.

In various embodiments, the notification light can sequentially illuminate two distinct frequencies or colors, can illuminate an arcuate section and effectively rotate the section along the circumference of the notification light over time, and can fully illuminate at a pre-established event or time.

### BRIEF DESCRIPTION OF THE DRAWINGS

FIG. 1 is a perspective view, partly in schematic, of a pencil sharpener incorporating a notification light;

FIG. 2 is a front elevational view of the pencil sharpener of FIG. 1;

FIG. 3 is a rear elevational view of the pencil sharpener of FIG. 1;

FIG. 4 is a top plan view of the pencil sharpener of FIG. 1;

FIG. 5 is a perspective view, partly in schematic, of the pencil sharpener of FIG. 1 with the cover removed;

FIG. 6 is a perspective view of the pencil sharpener of FIG. 1 with the cover removed and partially exploded;

FIG. 7 is a schematic circuit diagram for a control circuit for the pencil sharpener of FIG. 1;

FIG. 8 is a schematic circuit diagram for a second embodiment of a control circuit for the pencil sharpener of FIGS. 1; and

FIG. 9 is an enlarged sectional view, partly in schematic and portions removed, of an interior portion of the pencil sharpener of FIG. 1.

### DETAILED DESCRIPTION

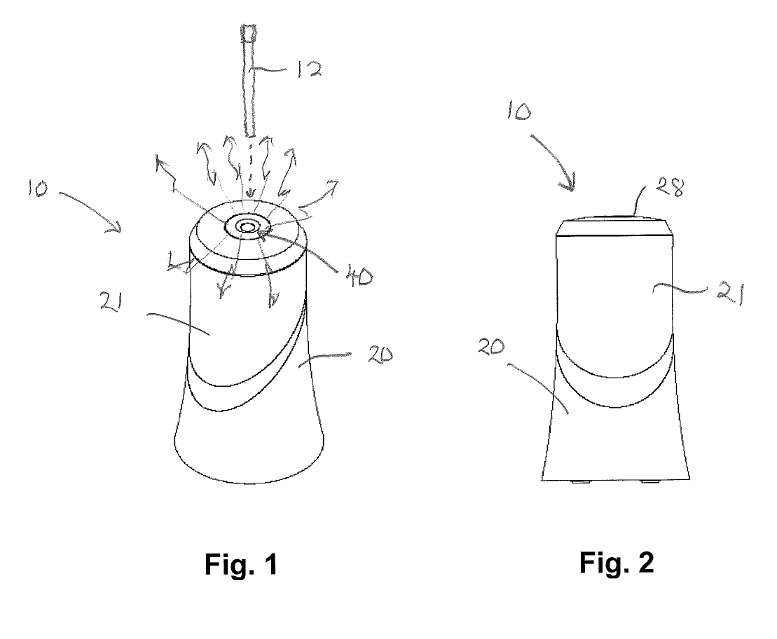

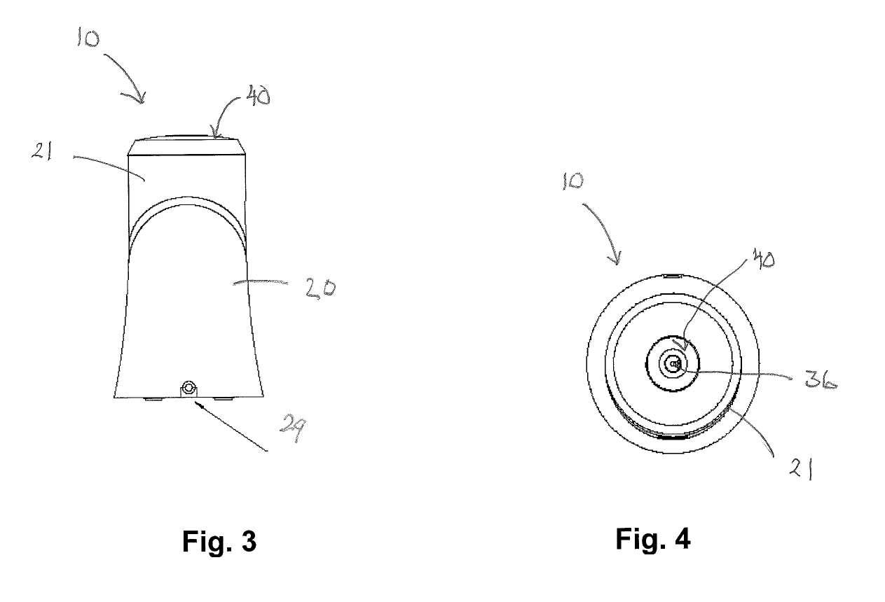

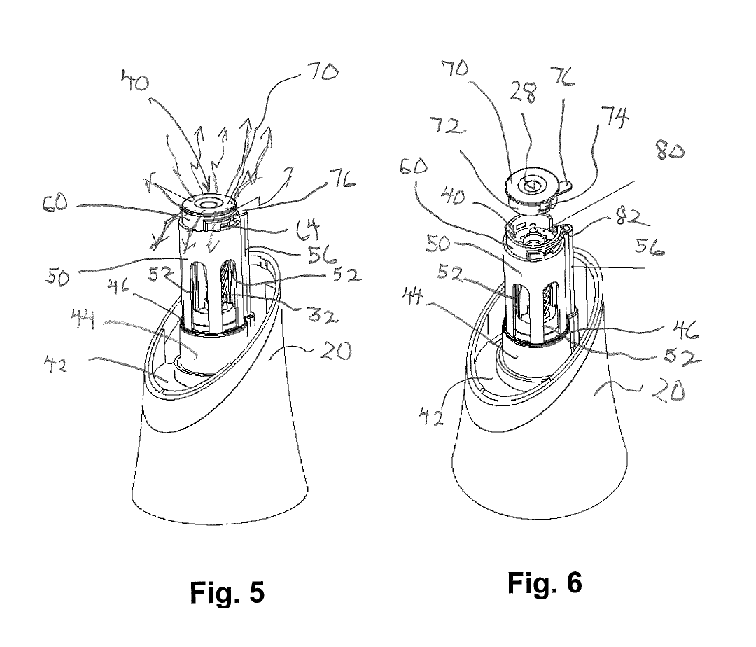

Referring to FIGS. 1-4, wherein like numerals indicate like elements throughout, there is shown a representative embodiment of an automatic pencil sharpener 10. The pencil sharpener 10, in accordance with the present disclosure, automatically sharpens a pencil 12 to a predetermined sharpness and illuminates a notification light (schematically illustrated in FIGS. 1 and 5) at a pre-established operational time to inform the user that the pencil is at the predetermined sharpness. The pencil sharpener is preferably adapted to be positioned on a desktop or other horizontal surface in an upright orientation for use as needed.

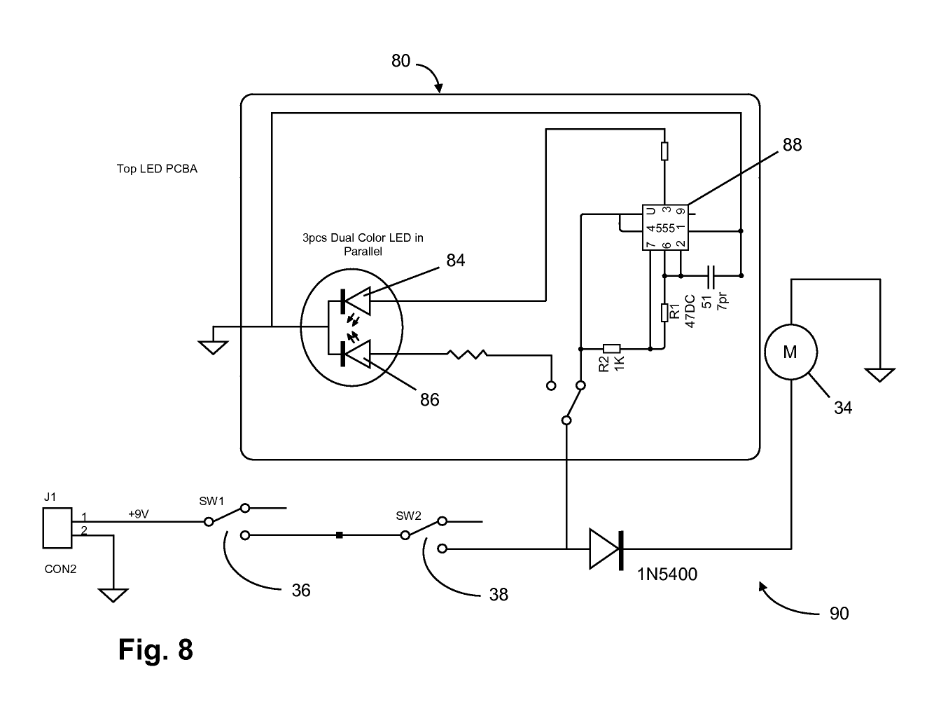

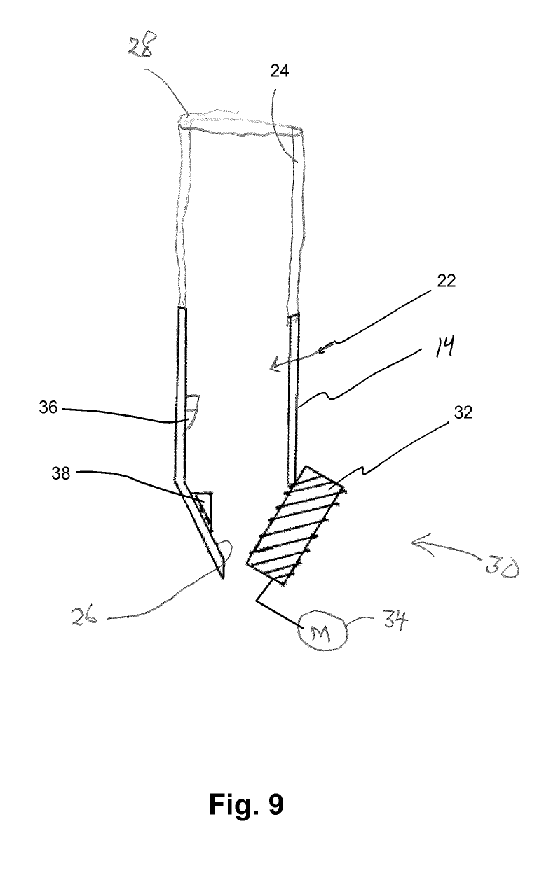

Referring to FIG. 1, an embodiment of the pencil sharpener 10 includes an upright housing assembly 20 with a removable cover 21. The housing assembly 20 has a generally vertical central receiver 22 having a first end 24 and a tapered second end 26. The receiver 22 receives a pencil to be sharpened. The receiver 22 is configured to receive a pencil 12 through access opening 28 at the first end 26. The housing assembly 12 contains a pencil sharpener mechanism 30 with a rotatable blade assembly 32 having at least one rotatable helical blade driven by a motor 34 operatively responsive to a sharpening switch 36 (FIGS. 4, 8 and 9). The pencil sharpener mechanism 30 is disposed for operation at the second end 26 of the receiver 22 and is configured to sharpen the pencil to a desired sharpness. An illuminatable notification light module 40 is disposed at an upper location. Power for the pencil sharpener is preferably supplied by a wall socket-mounted, power supply cord connecting at socket 29.

The rotary blade assembly 32 has a plurality of cutting surfaces, which may be straight or curved. The rotary blade assembly 32 is supported at an angle obliquely oriented relative to the central axis of receiver 22 and functions to produce the sharpened point configurations of the pencil. The central axis of the receiver 22 is vertical in the disclosed embodiment, but may have a different orientation in other embodiments. In one embodiment, the pencil sharpener mechanism 30 is supported by a safety spring (not depicted) to prevent damage to the pencil sharpener 10 due to excessive or improper use.

With reference to FIGS. 5 and 6, the cover 21 which retains the shavings from the sharpened pencils has been removed to reveal the blade assembly 32 and certain features of the notification light module 40. A platform 42 supports a stepped cylindrical case 44 which encloses at least some portions of the motor 34 and the linkage/mechanical connections with the blade assembly 32. A blade housing 50 which has angularly spaced, inverted U-shaped openings 52 is supported on the top edge 46 of the case. The top of the housing has an integral quasi-cylindrical coupler neck 60. A light transmissive cap 70, which may be translucent and/or transparent, includes a central opening defining access opening 28 for the pencil access to the receiver 22. The light transmissive cap 70 includes a reduced generally cylindrical side 72 with a resilient snap tab 74. The snap tab 74 is received in a complementary recess 64 at the interior of the coupler neck 60 to secure the cap 70 to the blade housing 50. In some embodiments, the cap 70 may be partially or completely transparent.

An LED printed circuit board assembly 80 is located at an upper location of the blade housing interior and has a central opening to accommodate the inserted pencil. The circuit board 80 mounts at least one LED. When the cap 70 is snapped in place on the blade housing 50, the printed circuit board assembly is located under the light transmissive cap 70 so that at least one LED is positioned to emit light through the cap.

A tunnel-like conduit 56 extends from the interior of the sharpener base axially to the top of the blade housing. Electrical wires 82 connect the main printed circuit board assembly 90 located in the housing base with the LED printed circuit board 80. The cap 70 has a radially projecting brim 76 which projects to cover the end of the conduit when the cap is snapped into place.

The LED circuit board assembly 80 preferably includes at least two LEDs 84 and 86 which emit at different frequencies. When the LEDs are energized, they illuminate at preferably different frequencies, such as, for example, in the green range for LED 84 and the red range for LED 86. The LEDs illuminate through the top of the translucent and/or transparent cap 70 to provide the notification light which is readily visible exteriorly of the pencil sharpener.

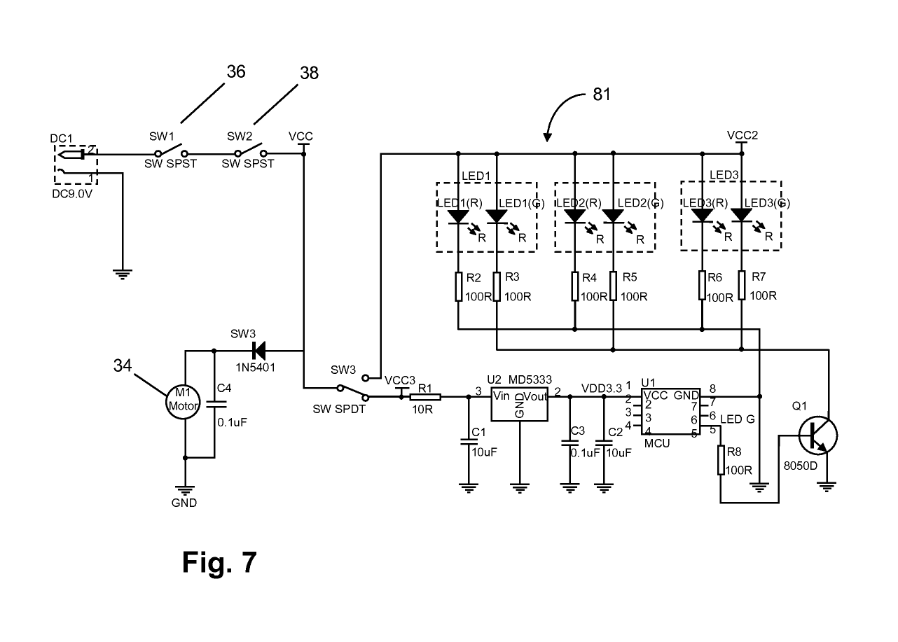

Various LED configurations and illumination patterns may be provided. Three pairs of angularly spaced LEDs may be provided as schematically illustrated in FIG. 7 for LED circuit board assembly 81.

In one embodiment (not illustrated), the three different LEDs are provided; a green LED, a red LED and a yellow LED. In some embodiments, the LEDs illuminate in a steady state illumination pattern. In other embodiments, one or more of the LEDs are pulsed. In other embodiments three angularly spaced pairs of LEDs are provided and a sequential illumination pattern is provided.

In one preferred operation, a green LED flashes during sharpening as detected by switch 36. A red LED illuminates in a steady state when the motor keeps rotating and the completed sharpening has been detected by switch 38. Naturally, other LED frequencies and patterns and sequences may be provided.

A sharpener control circuit 90 selectively connects via switches 36 and 38 with the motor 34 for the blade assembly 32. A green LED 84 and a red LED 86 are disposed in parallel. When the first switch 36 is tripped by inserting the pencil into the sharpener, a microprocessor 88 causes the green LED 84 to pulse. When the second switch 38 is tripped by virtue of the pencil being sufficiently sharpened and the motor continues operating, the red LED 86 is illuminated. Upon removal of the sharpened pencil from the sharpener, both the green LED 84 and the red LED 86 cease illumination.

When the switch 36 is depressed by the tip of a pencil (not depicted), the sharpener control circuit 90 also begins to operate the pencil sharpener mechanism 30 and illuminates the notification light module 40 at the first color. Upon activation of switch 38, the sharpener control circuit 90 switches the notification light to the second LED color 86. The pencil sharpener mechanism 32 continues to operate as long as the switch 38 is depressed. When the pencil is removed from contact with the switch 38 the switch 38, returns to its original “off” position and the notification light module 40 ceases illumination and the pencil sharpening mechanism 30 ceases operating.

In one embodiment, a notification light module generates an illumination annulus coaxially surrounding the access opening 28 and sequentially illuminates in two distinct colors. Initially, the notification light module partially illuminates a first color along an arcuate section when the pencil engages the pencil sharpener mechanism switch 36. If the pencil remains engaged with the pencil sharpener mechanism switch, the notification light module continues illuminating the first color, and the arcuate section rotates about the access opening 28 in the circumferential direction over time until the entire annulus of the notification light is illuminated in the first color. At a set time or when switch 38 is activated, the entire annulus of the notification light is illuminated in a second color. Naturally, multiple LEDs are required.

In the preferred depicted embodiments, the first color is green and the second color is red. The set time may be adjusted by the user to ensure that a desired sharpness of pencil is consistently achieved. In one embodiment, two separate notification lights are used in which each is illuminated in one of the two colors.

While preferred embodiments have been set forth for purposes of illustration, the foregoing descriptions should not be deemed a limitation of the invention herein. Accordingly, various modifications, adaptations and alternatives may occur to one skilled in the art without departing from the spirit and the scope of the present invention.

1. A pencil sharpener comprising:
a housing assembly having a pencil receiver extending from a first end proximate an exterior access opening to a second end, said access opening accommodating a pencil;
a pencil sharpening mechanism disposed in said housing assembly proximate said second end;
a sharpening switch disposed in said housing assembly in position to detect the presence of a pencil in said receiver;
a notification light module disposed in said housing assembly and upon illumination being configured to emit light visible from exteriorly of the housing assembly; and
a control unit operatively connected to said sharpening mechanism, said sharpening switch and said notification light module;
wherein when a pencil is inserted into said receiver and engages said sharpening switch, said control unit powers said pencil sharpening mechanism and illuminates said notification light module.

2. The pencil sharpener of claim 1, wherein said notification light module comprises an LED and the said housing assembly has a light transmissive portion wherein light emitted from said LED is transmitted through said light transmissive portion.

3. The pencil sharpener of claim 1, wherein said notification light module is disposed for emitting light in the vicinity of said access opening.

4. The pencil sharpener of claim 1, wherein said pencil sharpener comprises a second switch which is activatable upon sharpening said pencil at a second position, and said notification light module comprises at least two LEDs, one LED being illuminated upon activation of said first sharpening switch and a second LED being illuminated upon activation of said second switch.

5. The pencil sharpener of claim 4, wherein said first LED emits at a first frequency and said second LED emits at a second frequency.

6. The pencil sharpener of claim 5, wherein said first frequency is in the green range and the second frequency is in the red range.

7. The pencil sharpener of claim 5, wherein said first LED is pulsed and the second LED emits radiation at a steady state.

8. The pencil sharpener of claim 4, wherein said illumination from said first LED and said illumination from said second LED generally are disposed for transmission about said access opening.

9. The pencil sharpener of claim 4, wherein said pencil sharpener further comprises a blade guard having an upper portion, and said LEDs are mounted to a circuit board disposed at said upper portion of said blade guard assembly.

10. The pencil sharpener of claim 9, wherein said blade guard assembly further includes an axial conduit which extends from a lower portion to the upper portion and a wire extends through said conduit for connecting said LED circuit board assembly to a second circuit board assembly disposed in said housing assembly.

11. A pencil sharpener comprising:
a housing assembly having a pencil receiver extending from a first end proximate an exterior access opening to a second end, said access opening accommodating a pencil;
a pencil sharpening mechanism disposed in said housing assembly adjacent a portion of said receiver;
a first switch disposed in said housing assembly to detect the presence of a pencil at a first position of said receiver;
a second switch disposed in said housing assembly to detect the presence of the pencil at a second position of said receiver;
a notification light module disposed in said housing assembly and comprising two distinct lights which, upon illumination, are configured to emit light visible from exteriorly of the housing assembly; and
a control unit operatively connected to said sharpening mechanism, said first switch, said second switch and said notification light module;
wherein when a pencil is inserted into said receiver and said first switch is activated, said control unit powers said pencil sharpening mechanism and illuminates one light of said notification light module and when said second switch is activated, a second light of said notification light module is illuminated.

12. The pencil sharpener of claim 11, wherein said notification light module comprises a green LED and a red LED and the said housing assembly has a light transmissive portion wherein light emitted from said LED is transmitted through said light transmissive portion.

13. The pencil sharpener of claim 11, wherein said notification light module is disposed for emitting light in the vicinity of said access opening.

14. The pencil sharpener of claim 11, wherein said first LED is pulsed and the second LED emits radiation at a steady state.

15. The pencil sharpener of claim 11, wherein said pencil sharpener further comprises a blade guard having an upper portion and said LEDs are mounted to a circuit board disposed at said upper portion of said blade guard assembly.

16. The pencil sharpener of claim 15, wherein said blade guard assembly further includes an axial conduit which extends from a lower portion to the upper portion and a wire extends through said conduit for connecting said LED circuit board assembly to a second circuit board assembly disposed in said housing assembly.

17. A pencil sharpener comprising:
a housing assembly having a receiver extending from a first end adjacent an exterior access opening to a second end, said access opening accommodating a pencil and having a notification light which, when activated, is exteriorly visible from the housing assembly;
a pencil sharpener mechanism mounted to said housing assembly near said second end;
a sharpening switch disposed in said housing assembly; and
a sharpener control unit operatively connected to said sharpening switch and said sharpener mechanism;
wherein when a pencil is inserted in said receiver and said sharpening switch is activated, said sharpener control unit powers said pencil sharpener mechanism to sharpen the pencil and illuminates said notification light in a first color and at a subsequent time when the pencil sharpener mechanism is operated and said pencil is substantially completely sharpened, said sharpener control unit illuminates said notification light in a second color.

18. The pencil sharpener of claim 17, wherein said notification light is disposed adjacent said access opening.

19. The pencil sharpener of claim 17, wherein said notification light comprises at least one green LED and one red LED.

20. The pencil sharpener of claim 17, wherein said notification light ceases illumination when said pencil is withdrawn from said receiver.
